(19) United States
(12) Patent Application Publication
(10) Pub. No.: US 2025/0328326 A1
(43) Pub. Date: Oct. 23, 2025

(54) COMPILER PLUGIN FOR ENFORCING SAFETY AGREEMENTS

(71) Applicant: Red Hat, Inc., Raleigh, NC (US)

(72) Inventors: Pavel Odvody, Brno (CZ); Pierre-Yves Chibon, Puteaux (FR)

(21) Appl. No.: 18/643,992

(22) Filed: Apr. 23, 2024

(51) Int. Cl. G06F 8/41

(52) U.S. Cl. CPC G06F 8/443

(57) ABSTRACT

Techniques for verifying whether vendor-provided functions that are used in application code are compliant with a safety agreement are disclosed. Code comprising a plurality of functions are received at a compiler. During compilation of the code, a plugin of the compiler may determine whether each of the plurality of functions originates from a vendor. For each function originating from the vendor, the plugin may determine if the function is listed in a profile comprising a list of safety agreement compliant functions. The plugin may identify as compliant with the safety agreement, each function originating from the vendor that is listed in the profile.

### TECHNICAL FIELD

The present disclosure relates generally to software technology, and more particularly, to systems and methods of ensuring that functions provided by a vendor and included by e.g., a developer in an application comply with an agreement.

### BACKGROUND

Industries such as the automotive and aviation industries have a strong requirement for functional safety. Modern vehicles (e.g., automotive vehicles, marine vehicles, railed vehicles, aircraft vehicles, etc.) include computing systems that can execute one or more applications (e.g., software, computer code) to provide a variety of different critical services for managing the critical operations of the vehicle. For this reason, applications that execute on a vehicle's computing system are often classified as being either functional safety (FUSA) compliant or non-FUSA compliant (sometimes referred to as user application). An application that is classified as FUSA compliant is backed by a contractual agreement/engagement from a vendor of the application that the application will behave in a documented way and will follow certain best practices to ensure that this behavior is consistent over time and consistent through changes to the code.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example system, according to some embodiments of the present disclosure.

FIG. 2 is a block diagram of the system illustrated in FIG. 1, illustrating a compiler with a compliance plugin, according to some embodiments of the present disclosure.

FIGS. 3A and 3B are detailed block diagrams of the system illustrated in FIG. 1, illustrating the process of verifying whether vendor-provided functions are compliant with a safety agreement, according to some embodiments of the present disclosure.

FIG. 4 is a flow diagram depicting a method of verifying whether vendor-provided functions are compliant with a safety agreement, according to some embodiments of the present disclosure.

FIG. 5 is a block diagram of an example computing device that may perform one or more of the operations described herein, in accordance with some embodiments.

### DETAILED DESCRIPTION

A software library provided by a vendor may include numerous packages (e.g., thousands) and an even larger number of header files (e.g., hundreds of thousands), with each header file indicating one or more functions. However, only a fraction of these functions may be classified as FUSA compliant, while the remainder of functions may not be. As a result, a user of such software libraries (e.g., a software developer using the software libraries to write their own application) must bear the responsibility of making sure that their code only uses code from the software library that is FUSA compliant, so that the code of their application can be classified as FUSA compliant as well. Having to manually determine whether each function in vendor-provided software library is FUSA compliant may require considerable time and resources and may significantly slow down the software development process.

Aspects of the present disclosure address the above-noted and other deficiencies by providing a compiler plugin that verifies, during compilation of an application, whether vendor-provided functions that are included in the code of the application are in compliance with a safety agreement. If it is determined that one or more vendor-provided functions included in the code of the application are not in compliance with the safety agreement, the compilation process may fail and an error message may be provided.

When code comprising a plurality of functions are received at a compiler, a plugin of the compiler may prompt a user for a selection of a profile. During compilation of the code, the plugin may determine whether each of the plurality of functions originates from a vendor. For each function originating from the vendor, the plugin may determine if the function is listed in the profile, which comprises a list of safety agreement compliant functions. The plugin may identify as compliant with the safety agreement, each function originating from the vendor that is listed in the profile.

It should be noted that although described with respect to verifying whether functions are FUSA compliant or not, this is for example purposes only and not a limitation. The embodiments of the present disclosure may be used to determine if functions are compliant with any appropriate agreement, whether safety related or not.

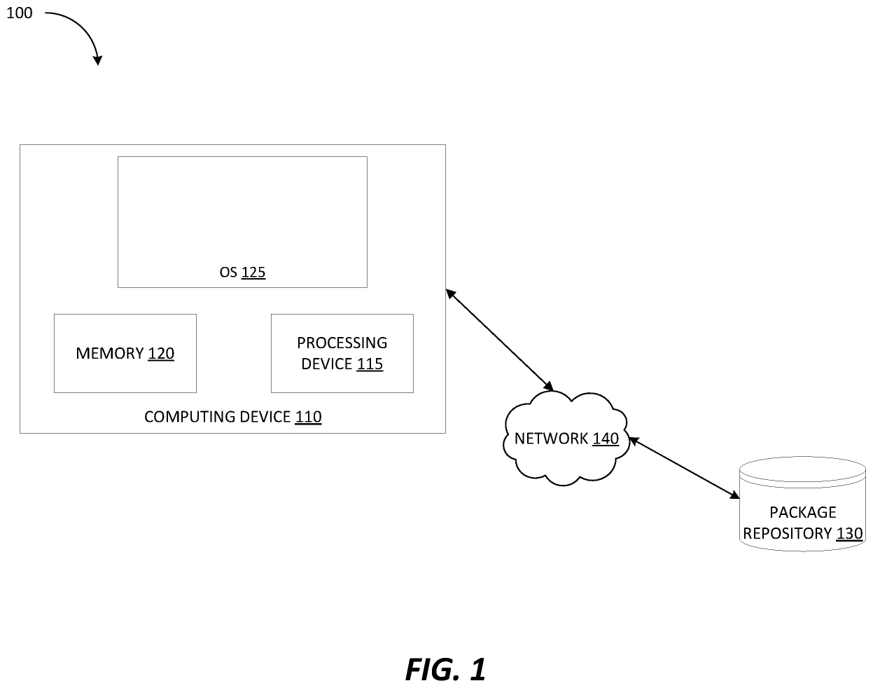

FIG. 1 is a block diagram that illustrates an example system 100. As illustrated in FIG. 1, the system 100 includes computing device 110, package repository 130 and a network 140. The computing device 110 and the package repository 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. The network 140 may carry communications (e.g., data, message, packets, frames, etc.) between computing device 110 and the package repository 130. The computing device 110 and the package repository 130 may each include hardware such as processing device 115 (e.g., processors, central processing units (CPUs), memory 120 (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

FIG. 1 and the other figures may use like reference numerals to identify like elements. A letter after a reference numeral, such as “112A,” indicates that the text refers specifically to the element having that particular reference numeral. A reference numeral in the text without a following letter, such as “112,” refers to any or all of the elements in the figures bearing that reference numeral.

The computing device 110 and the package repository 130 may each comprise any suitable type of computing device or machine that has a programmable processor including, for example, server computers, desktop computers, laptop computers, tablet computers, smartphones, set-top boxes, etc. In some examples, the computing device 110 and the package repository 130 may each comprise a single machine or may include multiple interconnected machines (e.g., multiple servers configured in a cluster). The computing device 110 and the package repository 130 may be implemented by a common entity/organization or may be implemented by different entities/organizations. For example, computing device 110 may be operated by a first company/corporation and package repository 130 may be operated by a second company/corporation. The computing device 110 and the package repository 130 may each execute or include an operating system (OS), as discussed in more detail below. The OSs of the computing device 110 (shown in FIG. 1 as OS 125) and the package repository 130 may manage the execution of other components (e.g., software, applications, etc.) and/or may manage access to the hardware (e.g., processors, memory, storage devices etc.) of their respective computing device. The OS 125 may be any appropriate enterprise OS that enables a user to build and deploy applications, such as Red Hat™ Enterprise Linux™.

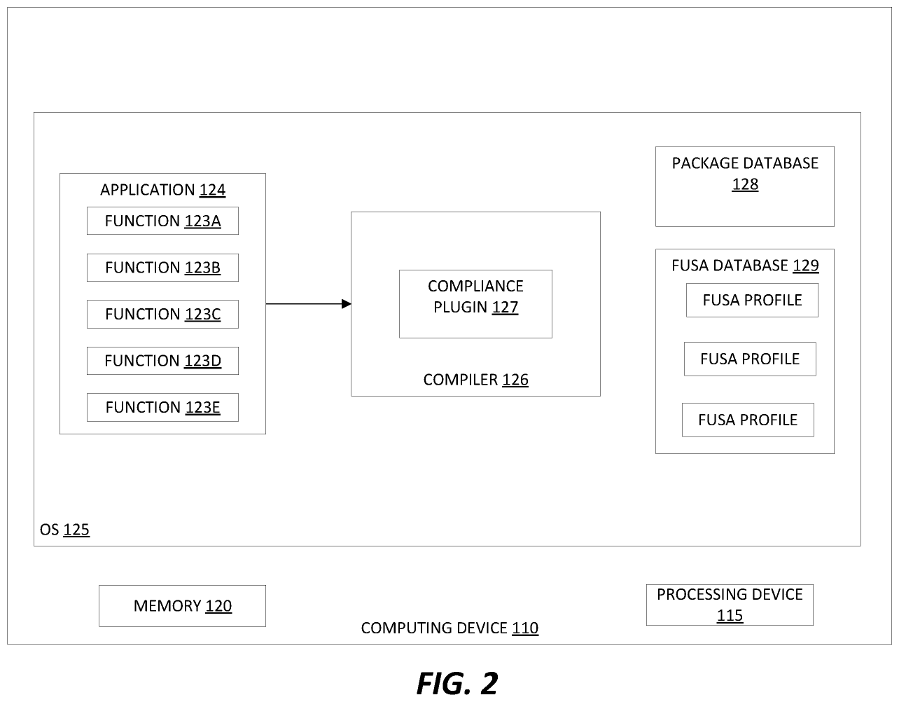

FIG. 2 illustrates the OS 125 in accordance with some embodiments of the present disclosure. The OS 125 may be provided by a vendor and may include a compiler 126, a package database 128 and a FUSA database 129. The vendor may also make a number of packages available to users for application development purposes. The vendor may provide such packages to the user via the package repository 130 and/or directly via the OS 125. When developing an application, a user can install vendor-provided packages and include functions (defined in the header files of the packages) provided by the installed packages in their code along with their own functions. The package database 128 may include information about all the packages installed on the OS 125, including information about each header file included in each installed package. The package database 128 may be modified whenever a new package is installed or an existing package is removed. The package database 128 can be used to query the information about what packages are installed and what header files are included in each installed package. The compiler 126 may include a compliance plugin 127, which may perform the functions described herein for ensuring that the vendor-provided functions included within a user's application code are FUSA compliant.

The FUSA database 129 may include one or more FUSA profiles, and each FUSA profile may include a list of vendor-provided functions that have been certified by the vendor as FUSA compliant. As different users (e.g., different customers) may require different lists of FUSA compliant functions (e.g., based on the type of application they are developing), having multiple FUSA profiles provides the flexibility to use the same compliance plugin 127 for different users. In addition, for each FUSA profile stored therein, the FUSA database 129 may include application program interface (API) information for each function listed within the FUSA profile. More specifically, for each entry in a FUSA profile, the FUSA database 129 may include API information of the corresponding function including a name of the function's source file (e.g.,/usr/include/stdio.h), a digest of the source file comprising a hash value resulting from processing the source file with a hash function, a specific line number in the source file where the function is declared, the symbol of the function (e.g., puts( ), f( )), and the names of the FUSA profiles in which the function can be used.

As illustrated in FIG. 2, a user may build an application 124 that includes one or more functions, shown as functions 123A-123E. Some of the functions 123A-123E may be provided by the vendor of the OS 125 (also referred to herein as vendor-provided), while others may be provided by the user themselves. When the user requests compilation of the code corresponding to the application 124, the compliance plugin 127 may prompt the user to select a FUSA profile corresponding to their desired FUSA compliant functions from the FUSA database 129. Once a selection of a FUSA profile has been received, the compiler 126 may begin compiling the code. During compilation of the code, the compliance plugin 127 may analyze each of the functions 123A-E to determine whether the functions are vendor-provided, and if so, whether they are FUSA compliant based on the selected FUSA profile, as discussed in further detail herein.

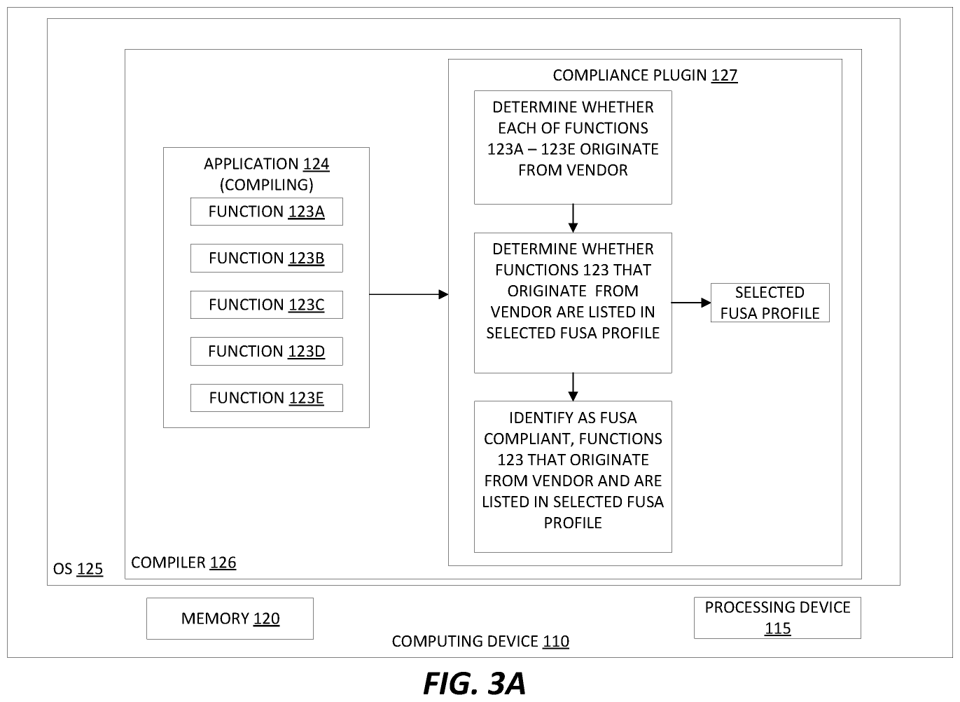

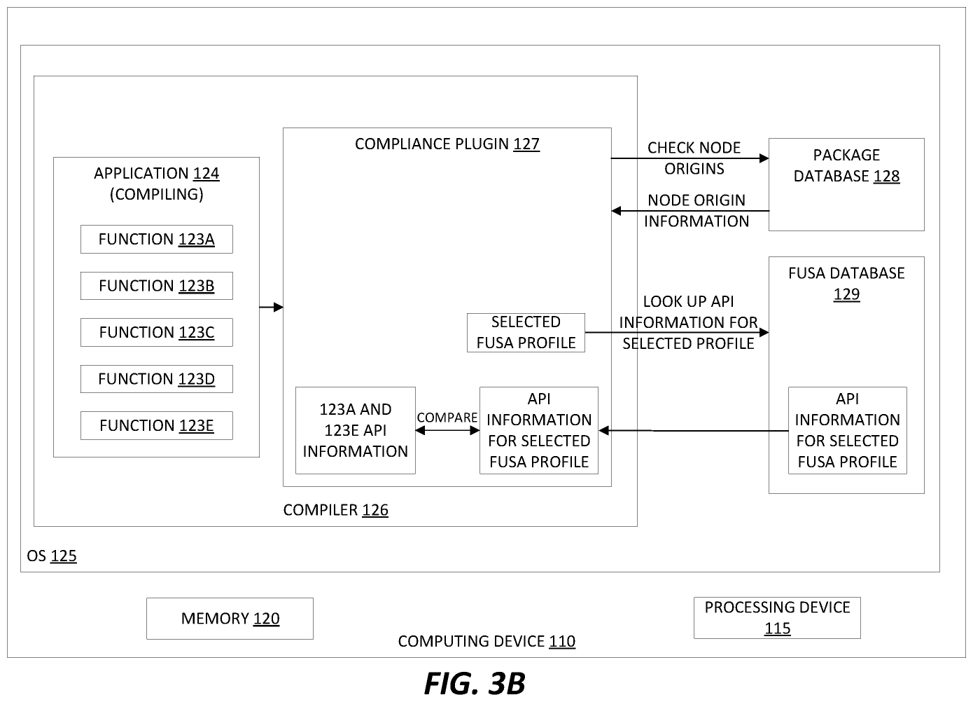

FIG. 3 illustrates the process of verifying whether the functions included in application 124 are vendor-provided, and if so, whether they are FUSA compliant. As discussed herein, prior to the compiler 126 initiating compilation of the code corresponding to application 124, the compliance plugin 127 may receive a selection of a FUSA profile corresponding to the FUSA compliant functions desired by the user. The compliance plugin 127 may retrieve and load the selected FUSA profile for use in verifying whether certain functions 123 are FUSA compliant as discussed in further detail herein.

While the code corresponding to application 124 is compiling, the compliance plugin 127 may determine whether each of the functions 123A-E are vendor-provided. The compiler 126 may utilize an abstract syntax tree (not shown) to represent the structure of the code of application 124. Each node of the abstract syntax tree may denote a construct occurring in the code such as e.g., a function. Upon generation by the compiler 126 of the abstract syntax tree for the code of application 124, the compliance plugin 127 may identify each node corresponding to a function 123 and determine from each identified node, the header file that the corresponding function 123 originates from. The compliance plugin 127 may look up each header file in the package database 128 to determine if the function 123 originates from a header file included in a vendor-provided package installed on the OS 125 (i.e., determine whether the function 123 is a vendor-provided function).

In the example of FIG. 3, the compliance plugin 127 may determine that functions 123A and 123E are vendor-provided functions, while functions 123B-123D are functions that originated with the user. The compliance plugin 127 may then look up the API information for each entry in the selected FUSA profile by querying the FUSA database 129. The FUSA database 129 may provide the API information for each FUSA compliant function in the selected FUSA profile to the compliance plugin 127. The compliance plugin 127 may compare the API information for each FUSA compliant function in the selected FUSA profile to the API information of the function 123A and the function 123E to determine if the functions 123A and 123E match any entries in the selected FUSA profile and are thus FUSA compliant. The compliance plugin 127 may ignore functions 123B-123D because these are not provided by the vendor of the OS 125.

The API information of a function 123 may include a name of the function 123's source file (e.g.,/usr/include/stdio.h), a digest of the source file, which is a hash value resulting from processing the source file with a hash function, a specific line number in the source file where the function is declared, and the symbol of the function (e.g., puts( ), f( )).

In the example of FIG. 3, the compliance plugin 127 may determine that both function 123A and function 123E are FUSA compliant functions, and thus may allow the compiler 126 to finish compiling the code of the application 124. More specifically, the compliance plugin 127 may determine that the name of the function 123A's source file matches the name of a source file corresponding to a particular function listed in the selected FUSA profile, that the digest of the function 123A's source file matches the digest of the source file corresponding to the particular function, that the specific line number in the function 123A's source file where the function 123A is declared matches the specific line number in the particular function's source file where the particular function is declared, and that the symbol of the function 123A matches the symbol of the particular function. The compliance plugin 127 may make a similar determination for function 123E. In some embodiments, the compiler plugin 127 may generate a message indicating that the code of the application 124 has been verified as only using vendor-provided functions that are FUSA compliant.

If however, the compliance plugin 127 determines that any of functions 123A and 123E do not have a matching entry in the selected FUSA profile and are thus not FUSA compliant, it may cause the compiling to fail and generate an error message informing the user that the compiling failed due to inclusion of a function(s) that is not FUSA compliant and indicating the function(s) that caused the failure.

It should be noted that although discussed with respect to a vendor of the OS 125, this is not a limitation and the embodiments of the present disclosure can apply to verifying compliance of functions provided by e.g., a vendor of hardware (such as the computing device 110).

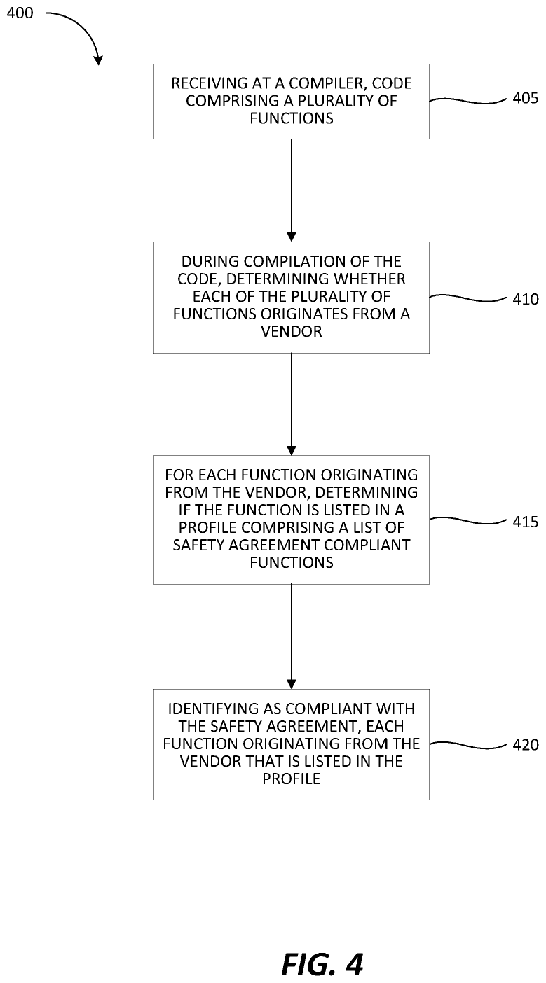

FIG. 4 is a flow diagram depicting a method 400 of verifying whether the vendor-provided functions included in the code of an application are FUSA compliant, according to some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof. In some embodiments, method 400 may be performed by processing device 115 (executing OS 125), as shown in FIGS. 2 and 3.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring also to FIGS. 2 and 3, a user may build an application 124 that includes one or more functions, shown as functions 123A-123E. Some of the functions 123A-123E may be provided by the vendor of the OS 125, while others may be provided by the user themselves. When the user requests compilation of the code corresponding to the application 124, at block 405 the complier 126 may receive the functions 123A-123E and the compliance plugin 127 may prompt the user to select a FUSA profile corresponding to their desired FUSA compliant functions from the FUSA database 129. Once a selection of a FUSA profile has been received, the compiler 126 may begin compiling the code.

At block 410, while the code corresponding to application 124 is compiling, the compliance plugin 127 may determine whether each of the functions 123A-E are vendor-provided. The compiler 126 may utilize an abstract syntax tree (not shown) to represent the structure of the code of application 124. Each node of the abstract syntax tree may denote a construct occurring in the code such as e.g., a function. Upon generation by the compiler 126 of the abstract syntax tree for the code of application 124, the compliance plugin 127 may identify each node corresponding to a function 123 and determine from each identified node, the header file that the corresponding function 123 originates from. The compliance plugin 127 may look up each header file in the package database 128 to determine if the function 123 originates from a header file included in a vendor-provided package installed on the OS 125 (i.e., determine whether the function 123 is a vendor-provided function).

In the example of FIG. 3, the compliance plugin 127 may determine that functions 123A and 123E are vendor-provided functions, while functions 123B-123D are functions that originated with the user. At block 415, the compliance plugin 127 may determine whether functions 123A and 123E are FUSA compliant based on the selected FUSA profile. More specifically, the compliance plugin 127 may look up the API information for each entry in the selected FUSA profile by querying the FUSA database 129. The FUSA database 129 may provide the API information for each FUSA compliant function in the selected FUSA profile to the compliance plugin 127. The compliance plugin 127 may compare the API information for each FUSA compliant function in the selected FUSA profile to the API information of the function 123A and the function 123E to determine if the functions 123A and 123E match any entries in the selected FUSA profile and are thus FUSA compliant. The compliance plugin 127 may ignore functions 123B-123D because these are not provided by the vendor of the OS 125.

The API information of a function 123 may include a name of the function 123's source file (e.g.,/usr/include/stdio.h), a digest of the source file, which is a hash value resulting from processing the source file with a hash function, a specific line number in the source file where the function is declared, and the symbol of the function (e.g., puts( ), f( )).

In the example of FIG. 3, the compliance plugin 127 may determine that both function 123A and function 123E are FUSA compliant functions, and thus may allow the compiler 126 to finish compiling the code of the application 124. More specifically, the compliance plugin 127 may determine that the name of the function 123A's source file matches the name of a source file corresponding to a particular function listed in the selected FUSA profile, that the digest of the function 123A's source file matches the digest of the source file corresponding to the particular function, that the specific line number in the function 123A's source file where the function 123A is declared matches the specific line number in the particular function's source file where the particular function is declared, and that the symbol of the function 123A matches the symbol of the particular function. The compliance plugin 127 may make a similar determination for function 123E. In some embodiments, the compiler plugin 127 may generate a message indicating that the code of the application 124 has been verified as only using vendor-provided functions that are FUSA compliant.

If however, the compliance plugin 127 determines that any of functions 123A and 123E do not have a matching entry in the selected FUSA profile and are thus not FUSA compliant, it may cause the compiling to fail and generate an error message informing the user that the compiling failed due to inclusion of a function(s) that is not FUSA compliant and indicating the function(s) that caused the failure.

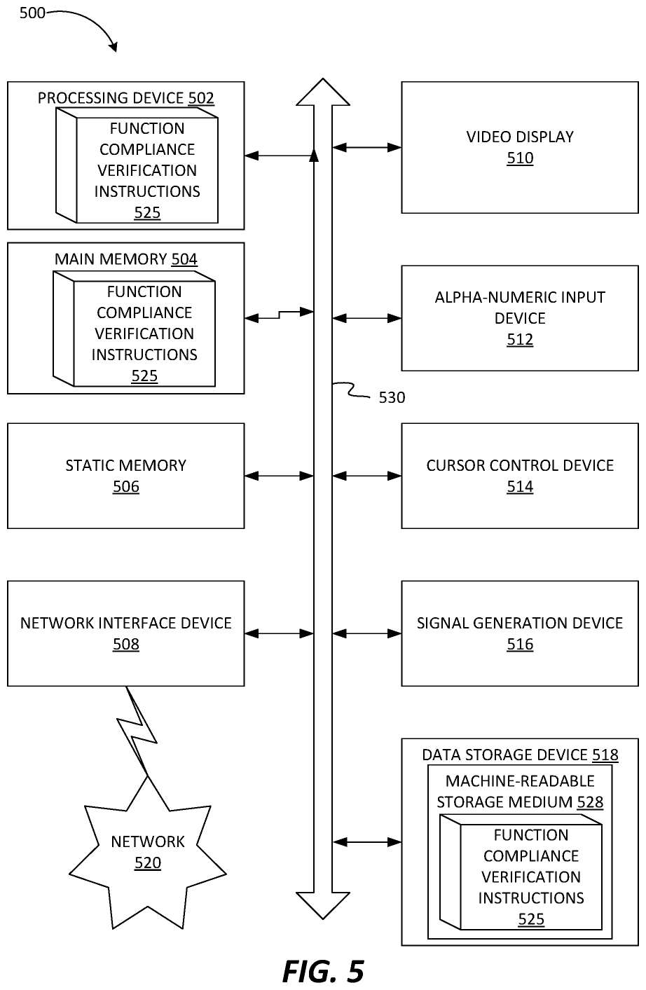

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a communication network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of function compliance verification instructions 525 that may include instructions for one or more components, agents, and/or functions (e.g., compliance plugin 126 in FIG. 3) for carrying out the operations described herein, in accordance with one or more aspects of the present disclosure. Function compliance verification instructions 525 may also reside, completely or at least partially, within main memory 504 and/or within processing device 502 during execution thereof by computing device 500, main memory 504 and processing device 502 also constituting computer-readable media. The function compliance verification instructions 525 may further be transmitted or received over a communication network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “allocating,” “detecting,” “migrating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving at a compiler, code comprising a plurality of functions;
during compilation of the code, determining whether each of the plurality of functions originates from a vendor;
for each function originating from the vendor, determining, by a processing device, if the function is listed in a profile comprising a list of safety agreement compliant functions; and
identifying as compliant with the safety agreement, each function originating from the vendor that is listed in the profile.

2. The method of claim 1, further comprising:
in response to determining that one or more of the functions originating from the vendor are not listed in the profile:
terminating the compilation of the code; and
providing an error message indicating the one or more functions originating from the vendor.

3. The method of claim 1, wherein determining whether each of the plurality of functions originates from the vendor comprises:
identifying each of the plurality of functions from a syntax tree generated by the compiler during compilation of the code; and
comparing each of the plurality of functions to a package database to determine if the function originates from a package provided by the vendor, wherein the package database comprises information regarding each package that is installed on an operating system on which the compiler executes.

4. The method of claim 1, wherein determining if a function originating from the vendor is listed in the profile comprises:
looking up, from a profile database, application program interface (API) information for each safety agreement compliant function listed in the profile; and
comparing API information for each function originating from the vendor to the API information for each safety agreement compliant function in the profile.

5. The method of claim 4, wherein the API information for each safety agreement compliant function in the profile comprises:
a name of the safety agreement compliant function's source file;
a hash value resulting from processing the source file with a hash function;
a specific line number in the source file where the safety agreement compliant function is declared; and
a symbol of the safety agreement compliant function.

6. The method of claim 1, further comprising:
receiving, by the compiler, a selection of the profile, where the profile is one of a plurality of profiles stored in a profile database.

7. The method of claim 1, wherein the compiler comprises a plugin, and wherein the plugin determines whether each of the plurality of functions originates from the vendor and determines if each function originating from the vendor is listed in the profile.

8. A system comprising:
a memory; and
a processing device operatively coupled to the memory, the processing device to:
receive at a compiler, code comprising a plurality of functions;
during compilation of the code, determine whether each of the plurality of functions originates from a vendor;
for each function originating from the vendor, determine if the function is listed in a profile comprising a list of safety agreement compliant functions; and
identify as compliant with the safety agreement, each function originating from the vendor that is listed in the profile.

9. The system of claim 8, wherein the processing device is further to:
in response to determining that one or more of the functions originating from the vendor are not listed in the profile:
terminating the compilation of the code; and
providing an error message indicating the one or more functions originating from the vendor.

10. The system of claim 8, wherein to determine whether each of the plurality of functions originates from the vendor, the processing device is to:
identify each of the plurality of functions from a syntax tree generated by the compiler during compilation of the code; and
compare each of the plurality of functions to a package database to determine if the function originates from a package provided by the vendor, wherein the package database comprises information regarding each package that is installed on an operating system on which the compiler executes.

11. The system of claim 8, wherein to determine if a function originating from the vendor is listed in the profile, the processing device is to:
look up, from a profile database, application program interface (API) information for each safety agreement compliant function listed in the profile; and
compare API information for each function originating from the vendor to the API information for each safety agreement compliant function in the profile.

12. The system of claim 11, wherein the API information for each safety agreement compliant function in the profile comprises:
a name of the safety agreement compliant function's source file;
a hash value resulting from processing the source file with a hash function;
a specific line number in the source file where the safety agreement compliant function is declared; and
a symbol of the safety agreement compliant function.

13. The system of claim 8, wherein the processing device is further to:
receiving, by the compiler, a selection of the profile, where the profile is one of a plurality of profiles stored in a profile database.

14. The system of claim 8, wherein the compiler comprises a plugin, and wherein the plugin determines whether each of the plurality of functions originates from the vendor and determines if each function originating from the vendor is listed in the profile.

15. A non-transitory computer-readable medium having instructions stored thereon which, when executed by a processing device, cause the processing device to:
receive at a compiler, code comprising a plurality of functions;
during compilation of the code, determine whether each of the plurality of functions originates from a vendor;
for each function originating from the vendor, determine, by the processing device, if the function is listed in a profile comprising a list of safety agreement compliant functions; and
identify as compliant with the safety agreement, each function originating from the vendor that is listed in the profile.

16. The non-transitory computer-readable medium of claim 15, wherein the processing device is further to:
in response to determining that one or more of the functions originating from the vendor are not listed in the profile:
terminating the compilation of the code; and
providing an error message indicating the one or more functions originating from the vendor.

17. The non-transitory computer-readable medium of claim 15, wherein to determine whether each of the plurality of functions originates from the vendor, the processing device is to:
identify each of the plurality of functions from a syntax tree generated by the compiler during compilation of the code; and
compare each of the plurality of functions to a package database to determine if the function originates from a package provided by the vendor, wherein the package database comprises information regarding each package that is installed on an operating system on which the compiler executes.

18. The non-transitory computer-readable medium of claim 15, wherein to determine if a function originating from the vendor is listed in the profile, the processing device is to:
look up, from a profile database, application program interface (API) information for each safety agreement compliant function listed in the profile; and
compare API information for each function originating from the vendor to the API information for each safety agreement compliant function in the profile.

19. The non-transitory computer-readable medium of claim 18, wherein the API information for each safety agreement compliant function in the profile comprises:
a name of the safety agreement compliant function's source file;
a hash value resulting from processing the source file with a hash function;
a specific line number in the source file where the safety agreement compliant function is declared; and
a symbol of the safety agreement compliant function.

20. The non-transitory computer-readable medium of claim 15, wherein the processing device is further to:
receiving, by the compiler, a selection of the profile, where the profile is one of a plurality of profiles stored in a profile database.
